(19) United States
(12) Patent Application Publication
(10) Pub. No.: US 2010/0274886 A1
(43) Pub. Date: Oct. 28, 2010

(54) VIRTUALIZED DATA STORAGE IN A VIRTUALIZED SERVER ENVIRONMENT

(76) Inventors: Nelson Nahum, Tustin, CA (US); Shyam Kaushik, Koramangala (IN); Vladimir Popovski, Irvine, CA (US); Itay Szekely, Yuvalim (IL)

Correspondence Address: Duft Bornsen & Fishman LLP, 1526 Spruce Street, Suite 302, Boulder County, CO, 80302, US

(21) Appl. No.: 12/429,519

(22) Filed: Apr. 24, 2009

(51) Int. Cl. G06F 15/173

(52) U.S. Cl. 709/224; 709/223

(57) ABSTRACT

Methods and systems for virtualizing a storage system within a virtualized server environment are presented herein. A computer network includes a first physical server configured as a first plurality of virtual servers. The computer network also includes a plurality of storage devices. The computer network also includes a first storage module operating on the first physical server. The first storage module is operable to configure the storage devices into a virtual storage device and monitor the storage devices to control storage operations between the virtual servers and the virtual storage device. The computer network also includes a second physical server configured as a second plurality of virtual servers. The second server includes a second storage module that is operable to maintain integrity of the virtual storage device in conjunction with the first storage module of the first physical server.

### BACKGROUND

1. Field of the Invention

The invention relates generally to storage systems and more specifically to virtualized storage systems in a computer network.

2. Discussion of Related Art

A typical large-scale storage system (e.g., an enterprise storage system) includes many diverse storage resources, including storage subsystems and storage networks. Many contemporary storage systems also control data storage and create backup copies of stored data where necessary. Such storage management generally results in the creation of one or more logical volumes where the data in each volume is manipulated as a single unit. In some instances, the volumes are managed as a single unit through a technique called “storage virtualization”.

Storage virtualization allows the storage capacity that is physically spread throughout an enterprise (i.e., throughout a plurality of storage devices) to be treated as a single logical pool of storage. Virtual access to this storage pool is made available by software that masks the details of the individual storage devices, their locations, and the manner of accessing them. Although an end user sees a single interface where all of the available storage appears as a single pool of local disk storage, the data may actually reside on different storage devices in different places. It may even be moved to other storage devices without a user's knowledge. Storage virtualization can also be used to control data services from a centralized location.

Storage virtualization is commonly provided by a storage virtualization engine (SVE) that masks the details of the individual storage devices and their actual locations by mapping logical storage addresses to physical storage addresses. The SVE generally follows predefined rules concerning availability and performance levels and then decides where to store a given piece of data. Depending on the implementation, a storage virtualization engine can be implemented by specialized hardware located between the host servers and the storage. Host server applications or file systems can then mount the logical volume without regard to the physical storage location or vendor type. Alternatively, the storage virtualization engine can be provided by logical volume managers that map physical storage associated with device logical units (LUNs) into logical disk groups and logical volumes

As storage sizes with these enterprise storage systems have increased over time, so too have the needs for accessing these storage systems. Computer network systems have an ever increasing number of servers that are used to access these storage systems. The manner in which these servers access the storage system have become increasingly complex due to certain customer driven requirements. For example, customers may use different operating systems at the same time, but each customer may not require the full processing capability of a physical server's hardware at a given time. In this regard, server virtualization provides the masking of server resources, including the number and identity of individual physical servers, processors, and operating systems, from server users. Thus, server virtualization is part of an overall virtualization trend in enterprise information technology in which the server environment desirably manages itself based on perceived activity. Server virtualization is also used to eliminate “server sprawl” and render server resources more efficient (e.g., improve server availability, assist in disaster recovery, centralize server administration, etc.).

One model of server virtualization is referred to as the virtual machine model. In this model, software is typically used to divide a physical server into multiple isolated virtual environments often called virtual private servers. The virtual private servers are based on a host/guest paradigm where each guest operates through a virtual imitation of the hardware layer of the physical server. This approach allows a guest operating system to run without modifications (e.g., multiple guest operating systems may run on a single physical server). A guest, however, has no knowledge of the host operating system. Instead, the guest requires actual computing resources from the host system via a “hypervisor” that coordinates instructions to a central processing unit (CPU) of a physical server. The hypervisor is generally referred to as a virtual machine monitor (VMM) that validates the guest issued CPU instructions and manages executed code requiring certain privileges. Examples of the virtual machine model server virtualization include VMware and Microsoft Virtual Server.

The advantages of the virtual servers being configured with a virtual storage device are clear. Management of the computing network is simplified as multiple guests are able to operate within their desired computing environments (e.g., operating systems) and store data in a common storage space. Problems arise, however, when a virtual storage system is coordinated with the virtual servers. Computing networks are often upgraded to accommodate additional computing and data storage requirements. Accordingly, servers and more often storage devices are added to the computing network to fulfill those needs. When these additions are implemented, the overall computing system is generally reconfigured to accommodate the additions. For example, when a new or storage element is added to the computing network, settings are manually changed in the storage infrastructure to accommodate such additions. However, these changes are error prone and generally risk “bringing down” the entire virtual server environment. Accordingly, there exists a need in which a computing network can implement additions to storage and/or server connectivity without interruption to the computing environments of the users.

### SUMMARY

The present invention solves the above and other problems, thereby advancing the state of the useful arts, by providing methods and systems for virtualizing a storage system within a virtualized server environment. In one embodiment, a computer network includes a first physical server configured as a first plurality of virtual servers, a plurality of storage devices, and a first storage module operating on the first physical server. The first storage module is operable to configure the storage devices into a virtual storage device and monitor the storage devices to controls storage operations between the virtual servers and the virtual storage device. The computer network also includes a second physical server configured as a second plurality of virtual servers. The second server includes a second storage module. The second storage module is operable to maintain integrity of the virtual storage device in conjunction with the first storage module of the first physical server.

The virtual storage device may include an additional storage device to the plurality of the storage devices to expand a storage capability of the virtual storage device (e.g., an upgrade). The first and second storage modules may be operable to detect the additional storage device and configure the additional storage device within the virtual storage device. The first and second storage modules may be storage virtualization modules comprising software instructions that direct the first and second physical servers to maintain the integrity of the virtual storage device. The first and second storage modules may be standardized to operate with a plurality of different operating systems via software shims.

The computer network may also include a user interface operable to present a user with a storage configuration interface. The storage configuration, in this regard, interface is operable to receive storage configuration input from the user to control operation of the virtual storage device and each of the storage modules.

In another embodiment, a method of operating a computing network includes configuring a first physical server into a first plurality of virtual servers, configuring the first physical server with a first storage module, configuring a second physical server with a second storage module, and configuring a plurality of storage devices into a virtual storage device with the first and second storage modules. The method also includes cooperatively monitoring the virtual storage device using the first and second storage modules to ensure continuity of the virtual storage device during storage operations of the first plurality of virtual servers.

In another embodiment, a storage virtualization software product includes a computer readable medium embodying a computer readable program for virtualizing a storage system to a plurality of physical servers and a plurality of virtual servers operating on said plurality of physical servers. The computer readable program when executed on the physical servers causes the physical servers to perform the steps of configuring a plurality of storage devices into a virtual storage device and controlling storage operations between the virtual servers and the virtual storage device.

In another embodiment, a storage system includes a plurality of storage devices and a plurality of storage modules operable to present the plurality of storage devices as a virtual storage device to a plurality of virtual servers over a network communication link. Each storage module communicates with one another to monitor the storage devices and control storage operations between the virtual servers and the virtual storage device. The virtual servers may be operable with a plurality of physical servers. The storage modules may be respectively configured as software components within the physical servers to control storage operations between the virtual servers and the virtual storage device. The storage modules may communicate to one another via communication interfaces of the physical servers to monitor the storage devices.

### BRIEF DESCRIPTION OF THE DRAWINGS

FIG. 1 is an exemplary block diagram of a computing system that includes a virtualized storage system operable with a virtualized server.

FIG. 2 is an exemplary block diagram of another computing system that includes the virtualized storage system operable with a plurality of virtualized servers.

FIG. 3 is an exemplary block diagram of a server system having server modules configured with storage virtualization modules.

FIG. 4 is a flowchart of a process for operating storage virtualization within a virtualized server environment.

### DETAILED DESCRIPTION OF THE DRAWINGS

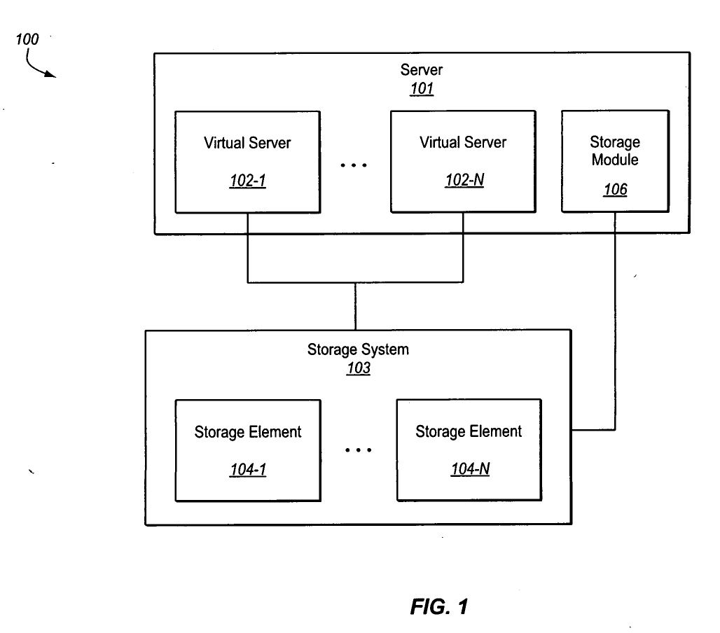

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 is an exemplary block diagram of a computing system 100 operable with a virtualized server 101 and a virtualized storage system 103. In this embodiment, the server 101 is a physical server that has been virtualized to include virtual servers 102-1 . . . N, wherein N is an integer greater than 1. For example, when virtualizing the server 101, server resources (e.g., the number and identity of individual physical servers, processors, operating systems, etc.) are generally masked from server users. To do so, a server administrator may divide the server 101 via software into multiple isolated virtual server environments, generally called virtual servers 102, with each being capable of running its own operating system and applications. In this regard, the virtual server 102 appears to the server user just as a typical physical server would. The number of virtual servers 102 operating with a particular physical server may be limited to the operational capabilities of the physical server. That is, a virtual server 102 generally may not operate outside the actual capabilities of the physical server. In one embodiment, the server 101 is virtualized using virtualization techniques provided by VMware of Palo Alto, Calif.

Also configured with the computing system 100 is the virtualized storage system 103. The virtualized storage system 103 includes storage elements 104-1 . . . N, wherein N is also a number greater than 1 although not necessarily equal to the number of virtual servers 102-1 . . . N. The storage elements 104 are consolidated through the use of hardware, firmware, and/or software into an apparently single storage system that each virtual server 102 can “see”. For example, the server 101 may be configured with a storage module 106 that is used to virtualize the storage system 103 by making individual storage elements 104 appear as a single contiguous system of storage space. In this regard, the storage module 106 may include LUN maps that are used to direct read and write operations between the virtual servers 102 and the storage system 103 such that the identity and locations of the individual storage elements 104 are concealed from the virtual servers 102. In one embodiment, the storage module 106 may include a Fastpath storage driver, a “Storage Fabric” Agent (“FAgent”), and a storage virtualization manager (SVM) each produced by LSI Corporation of Milpitas, Calif.

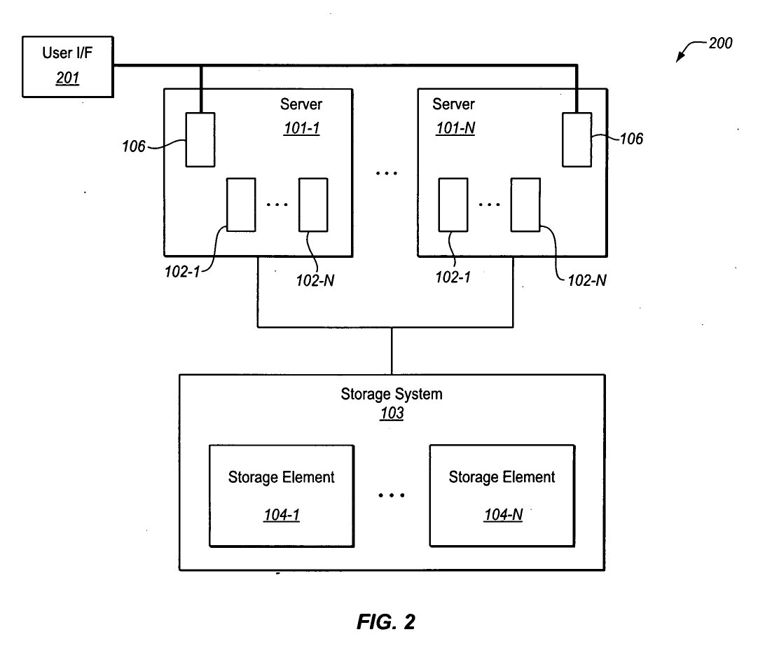

FIG. 2 is another exemplary block diagram of another computing system 200 that includes the virtualized storage system 103 operable with a plurality of virtualized servers 102-1 . . . N. In this embodiment, the computing system 200 is configured with a plurality of physical servers 101-1 . . . N with each physical server 101 being configured with a plurality of virtual servers 102. Again, the “N” designation is merely intended to indicate an integer greater than 1 and not necessarily equating any number of elements to one another. For example, a member of virtual servers 102 within the physical server 101-1 may differ from the number of virtual servers 102 within the physical server 101-N. Each virtual server 102 within the computing system 200 is operable to direct read and write operations to the virtualized storage system 103 as though the virtualized storage system 103 were a contiguous storage space. This virtualization of the storage system 103 may be accomplished through the storage modules 106 of each of the servers 101. For example, the storage modules 106 may be preconfigured with LUN maps that ensure that the virtual servers 102, and for that matter the physical servers 101, do not overwrite one another. That is, the LUN maps of the storage modules 106 may ensure that the storage modules 106 cooperatively control the storage operations between the virtual servers 102 and the storage system 103.

To configure the storage system 103 as a virtualized storage system of multiple storage elements 104, the computing system 200 may be configured with a user interface 201 that is communicatively coupled to the storage modules 106. For example, the storage modules 106 may include software that allows communication to the storage modules 106 via a communication interface of the server 101 or some other processing device, such as a remote terminal. A system administrator, in this regard, may access the storage modules 106 when changes are made to the storage system 103. For example, upgrades to the storage system 103 may be provided over time in which additional and/or different storage elements 104 are configured with the storage system 103. To ensure that the storage space remains virtually contiguous between the virtual servers 102 and the storage system 103, a system administrator may change the LUN mappings of the storage system 103 within the storage modules 106 via the user interface 201.

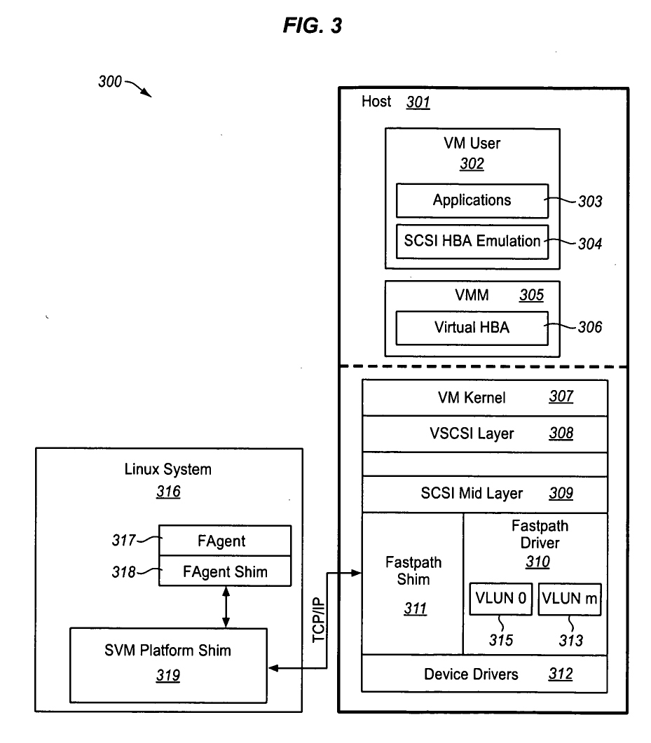

In one embodiment, each storage module 106 of each physical server 101 includes a FastPath storage driver. A portion of the storage modules 106 may also include an FAgent and an SVM, each being configured by a user through, for example, the user interface 201. One reason why fewer FAgents than FastPath storage drivers may exist is due to the fact that multiple FastPath storage drivers may be managed by a single FAgent thereby minimizing the “software footprint” of the overall storage system within the computing environment. The FastPath storage drivers may be responsible for directing read/write I/Os according to preconfigured virtualization tables (e.g., LUN maps) that control storage operations to the LUNs. Should I/O problems occur, read/write I/O operations may be defaulted to the FAgent of the storage module 106. Exemplary configurations of a FastPath storage driver, an FAgent, and an SVM with a physical server are illustrated in FIG. 3.

FIG. 3 is an exemplary block diagram of a server system 300 that includes server modules configured with storage virtualization modules, including the FastPath storage driver 310, the FAgent 317, and the SVM 319. The server system 300 is configured with a host operating system 301 and a virtual machine kernel 307. The host operating system 301 generally regards the operating system employed by the physical server and includes modules that allow virtualization of the physical server into a plurality of virtual private servers. In this regard, a host operating system 301 may include a virtual machine user module 302 that includes various applications 303 and a SCSI host bus adapter emulation module 304. The virtual machine user module 302 may also include a virtual machine monitor 305 that includes a virtual host bus adapter 306. Each of these may allow the virtual user to communicate with various hardware devices of the physical server. For example, the SCSI host bus adapter emulation module 304 may allow a virtual user to control various hardware components of the physical server via the SCSI protocol. In this regard, the virtual servers and for that matter the physical server may view a virtualized storage system as a typical storage device, such as disk drive. To do so, the physical server may include a virtual machine kernel 307 that includes a virtual SCSI layer 308 and SCSI mid layer 309. The virtual machine kernel 307 may also allow control of other hardware components of the physical server by the virtual servers via other device drivers 312.

The virtual machine kernel 307 may include a FastPath shim 311 configured with the FastPath driver 310 to allow the virtual machine user to store data within the storage system 103 as though it were a single contiguous storage space. That is, the FastPath driver 310 may direct read/write I/Os according to the virtualization tables 313 and 315, which provide for the LUN designations of the storage system 103. In one embodiment, the FastPath driver 310 is a standard software-based driver that may be implemented in a variety of computing environments. Accordingly, the virtual machine kernel 307 may include the FastPath shim 311 to allow the FastPath driver 310 to be implemented with little or no modification.

As with virtualization of the physical server system 300, a physical server system 300 may have a plurality of virtual machine users, each capable of employing their own operating systems. As one example, a virtual machine user may employ a Linux-based operating system 316 for the virtual server 102. So that the virtual server 102 observes the storage system 103 as a single contiguous storage space (i.e., a virtualized storage system), the Linux-based operating system 316 of the virtual server 102 may include the FAgent 317 and the FAgent shim 318. For example, the FAgent 317 maybe a standard software module. The FAgent shim 318 may be used to implement the FAgent 317 within a plurality of different operating system environments. As mentioned, the FAgent 317 may be used by the virtual server 102 when various I/O problems occur. In this regard, problematic I/Os may be defaulted to the FAgent to be handled via software. Moreover, the FAgent 317 may be used to manage one or more FastPath drivers 310. The FAgent 317 may also determine active ownership for a given virtual volume. That is, the FAgent 317 may determine which FAgents within the plurality of physical servers 101 has control over the storage volumes of the storage system 103 at any given time. In this regard, the FAgent 317 may route I/O faults and any exceptions of a virtual volume to a corresponding FAgent. The FAgent 317 may also scanned all storage volumes of the storage system 103 to determine which are available to the host system 301 at the SCSI mid-layer 309 and then present virtual volumes to the virtual machine kernel 307 as typical SCSI disk drive devices.

The SVM 319 is generally responsible for the discovery of the storage area network (SAN) objects. For example, the SVM 319 may detect additions or changes to the storage system 103 and alter I/O maps to ensure that the storage system 103 appears as a single storage element. The SVM 319 may communicate to the FastPath Driver 310 (e.g., via the FastPath Shim311) to provide an interface to the FastPath Driver 310 through which a user may configure the FastPath Driver 310. For example, the SVM 319 may provide the user interface 201 that allows a system administrator access to the configuration tables or LUN maps of the storage system 103 when a change is desired with the storage system 103 (e.g., addition/change of disk drives, storage volumes, etc.). In one embodiment, the communication link is a TCP/IP connection, although other forms of communication may be used.

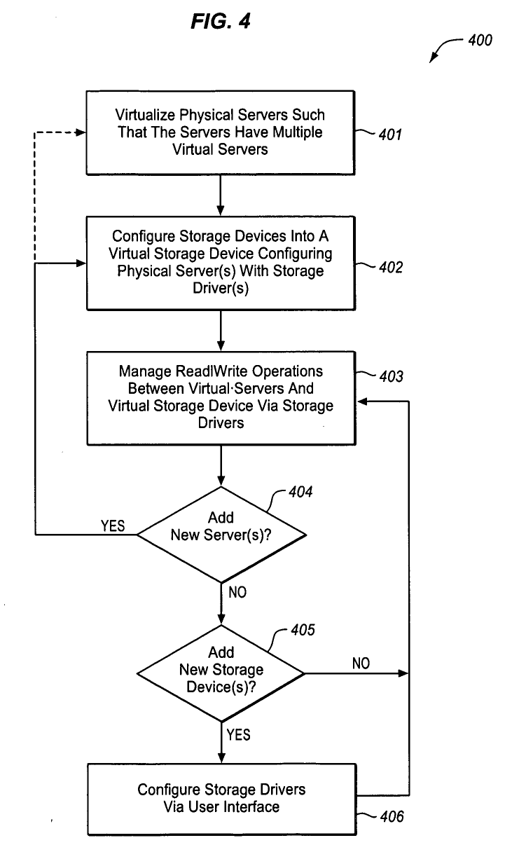

FIG. 4 is a flowchart of a process 400 for operating storage virtualization within a virtualized server environment. In this embodiment, the process 400 initiates with the virtualization of physical servers such that each physical server has multiple virtual servers, in the process element 401. Concomitantly, a plurality of storage devices may be virtualized into a single virtual storage device in the process element 402 such that the virtual storage device appears as a single contiguous storage space to devices accessing the virtual storage device. With the physical servers and the storage devices virtualized, read/write operations between the virtual servers and the virtual storage devices may be managed in the process element 403 such that storage space is not improperly overwritten. For example, each of the physical servers may be configured with storage virtualization modules that ensure the virtual servers, and for that matter the physical servers, maintain the integrity of the storage system. Occasionally, upgrades to a computing environment may be deemed necessary. In this regard, a determination may be made regarding the addition of physical servers in the process element 404. Should new physical servers be required, the physical servers may be configured with the storage virtualization modules to ensure that the physical servers maintain the integrity of the virtualized storage system by returning to the process element 402. Should the physical servers also require virtualization to have a plurality of virtual private servers operating thereon, the process element 404 may alternatively return to the process element 401.

Similarly, a determination may be made regarding the addition of storage devices to the computing system, in the process element 405. Assuming that changes are made to the storage system, the storage modules of the physical servers may be reconfigured in the process element 406 via a user interface. For example, one or more of the physical servers may be configured with an SVM that presents a user interface to the system administrator such that the system administrator may alter the LUN maps of the virtualized storage system as described above. Regardless of any additions or changes to the virtualized systems for the virtualized server system, the storage modules of the physical servers that virtualize the storage system from a plurality of storage devices continue managing read/write operations between the virtual servers in the virtual storage system of the process element 403.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A computer network, comprising:
a first physical server configured as a first plurality of virtual servers;
a plurality of storage devices;
a first storage module operating on the first physical server, wherein the first storage module is operable to configure the storage devices into a virtual storage device and wherein the first storage module monitors the storage devices and controls storage operations between the virtual servers and the virtual storage device; and
a second physical server configured as a second plurality of virtual servers,
wherein the second server comprises a second storage module, wherein the second storage module is operable to maintain integrity of the virtual storage device in conjunction with the first storage module of the first physical server.

2. The computer network of claim 1, wherein the virtual storage device comprises an additional storage device to the plurality of the storage devices, wherein the additional storage device is operable to expand a storage capability of the virtual storage device.

3. The computer network of claim 2, wherein the first and second storage modules are operable to detect the additional storage device and configure the additional storage device within the virtual storage device.

4. The computer network of claim 1, further comprising a user interface operable to present a user with a storage configuration interface, wherein the storage configuration interface is operable to receive storage configuration input from the user to control operation of the virtual storage device and each of the storage modules.

5. The computer network of claim 1, wherein the first and second storage modules are storage virtualization modules comprising software instructions that direct the first and second physical servers to maintain the integrity of the virtual storage device.

6. The computer network of claim 1, wherein the first and second storage modules are standardized to operate with a plurality of different operating systems via software shims.

7. A method of operating a computing network, the method comprising:
configuring a first physical server into a first plurality of virtual servers;
configuring the first physical server with a first storage module;
configuring a second physical server with a second storage module;
configuring a plurality of storage devices into a virtual storage device with the first and second storage modules; and
cooperatively monitoring the virtual storage device using the first and second storage modules to ensure continuity of the virtual storage device during storage operations of the first plurality of virtual servers.

8. The method of claim 7, further comprising adding a storage device to the plurality of storage devices and recognizing the added storage device with the first and second storage modules.

9. The method of claim 7, further comprising providing a user interface, wherein the user interface is operable to receive input from a user to configure the first and second storage modules and control the storage operations of the virtual servers to the virtual storage device.

10. The method of claim 7, further comprising controlling the second storage module via a storage virtualization manager configured with the first storage module.

11. The method of claim 7, wherein the first and second storage modules are storage virtualization modules comprising software instructions that direct the first and second physical servers to maintain the integrity of the virtual storage device.

12. The method of claim 7, wherein configuring the first and second servers with the first and second storage modules comprises configuring the first and second physical servers with software shims operable to enable operation of standardized software versions of the first and second storage modules on a plurality of different operating systems.

13. The method of claim 7, further comprising configuring the second physical server into a second plurality of virtual servers.

14. A storage virtualization software product, comprising a computer readable medium embodying a computer readable program for virtualizing a storage system to a plurality of physical servers and a plurality of virtual servers operating on said plurality of physical servers, wherein the computer readable program when executed on the physical servers causes the physical servers to perform the steps of:
configuring a plurality of storage devices into a virtual storage device; and
controlling storage operations between the virtual servers and the virtual storage device.

15. The storage virtualization software product of claim 14, further causing the physical servers to perform the steps of:
recognizing a newly added storage device; and
configuring the newly added storage device within the virtual storage device for presentation to the virtual servers.

16. The storage virtualization software product of claim 14, further causing the physical servers to perform the step of:
monitoring the virtual storage device in conjunction with each other to ensure continuity of the virtual storage device.

17. The storage virtualization software product of claim 14, further causing the physical servers to perform the step of:
providing a user interface that is operable to receive input from a user to control the storage operations between the virtual servers and the virtual storage device.

18. A storage system, comprising:
a plurality of storage devices; and
a plurality of storage modules operable to present the plurality of storage devices as a virtual storage device to a plurality of virtual servers over a network communication link, wherein each storage module communicates with one another to monitor the storage devices and control storage operations between the virtual servers and the virtual storage device.

19. The storage system of claim 18, wherein virtual servers are operable with a plurality of physical servers, wherein the storage modules are respectively configured as software components within the physical servers to control storage operations between the virtual servers and the virtual storage device, and wherein the storage modules communicate to one another via communication interfaces of the physical servers to monitor the storage devices.

20. The storage system of claim 18, further comprising a user interface operable to present a user with a storage configuration interface, wherein the storage configuration interface is operable to receive storage configuration input from the user to control operation of the virtual storage device and each of the storage modules.
